(19) United States
(12) Patent Application Publication
(10) Pub. No.: US 2025/0096447 A1
(43) Pub. Date: Mar. 20, 2025

(54) RESONATOR FOR FILTERS

(71) Applicant: Nokia Solutions and Networks Oy, Espoo (FI)

(72) Inventor: Efstratios DOUMANIS, Stuttgart (DE)

(21) Appl. No.: 18/888,559

(22) Filed: Sep. 18, 2024

(30) Foreign Application Priority Data
Sep. 20, 2023 (GR) 20230100756

(51) Int. Cl. H01P 1/207; H04B 1/10

(52) U.S. Cl. CPC H01P 1/207; H04B 1/10

(57) ABSTRACT

The present subject matter relates to a resonator comprising a chamber comprising a first wall, a second wall opposite the first wall, and side walls; a first cylinder grounded on one of the first and second walls and extending into the chamber; a second cylinder which is coaxial with the first cylinder and grounded on the other wall of the first and second walls and extending into the chamber; a tuner being coaxial with the second cylinder and grounded on the bottom of the first cylinder; and a dielectric tube is configured to circumscribe the tuner along an overlap length.

### TECHNICAL FIELD

Various example embodiments relate to resonators and filters, such as radio frequency resonators and filters.

### BACKGROUND

Filters are widely used in telecommunications. Their applications vary from mobile cellular base stations, through radar systems, amplifier linearization, to point-to-point radio and radio frequency (RF) signal cancellation, to name a few. The choice of a filter is ultimately dependent on the application; however, there are certain desirable characteristics that are common to all filter realisations. For example, the amount of insertion loss in the pass-band of the filter should be as low as possible, while the attenuation in the stop-band should be as high as possible. Further, in some applications, the guard band—the frequency separation between the pass-band and stop-band-needs to be very small, which requires filters of high-order to be deployed in order to achieve this requirement. However, the requirement for a high-order filter may always be accompanied by an increase in the cost (due to a greater number of components that a filter requires) and size. Furthermore, even though increasing the order of the filter increases the attenuation in the stop-band, this inevitably increases the losses in the pass-band. One of the challenging tasks in filter design is filter size reduction with a simultaneous retention of excellent electrical performance comparable with larger structures.

### SUMMARY

Example embodiments provide a resonator comprising: a chamber comprising a first wall, a second wall opposite the first wall, and side walls; a first cylinder grounded on one of the first and second walls and extending into the chamber; a second cylinder which is coaxial with the first cylinder and grounded on the other wall of the first and second walls and extending into the chamber; a tuner being coaxial with the second cylinder and grounded on the bottom of the first cylinder; and a dielectric tube being coaxial with the second cylinder. The dielectric tube may be configured to circumscribe the tuner along an overlap length.

Example embodiments provide a method of radio frequency filtering comprising passing a signal for filtering through at least one resonator, the resonator comprising a chamber comprising a first wall, a second wall opposite the first wall, and side walls; a first cylinder grounded on one of the first and second walls and extending into the chamber; a second cylinder which is coaxial with the first cylinder and grounded on the other wall of the first and second walls and extending into the chamber; a tuner being coaxial with the second cylinder and grounded on the bottom of the first cylinder; and a dielectric tube being coaxial with the second cylinder. The dielectric tube may be configured to circumscribe the tuner along an overlap length.

### BRIEF DESCRIPTION OF THE DRAWINGS

The accompanying figures are included to provide a further understanding of examples, and are incorporated in and constitute part of this specification. In the figures:

FIG. 1 schematically depicts a cross-sectional side view of a resonator according to an example of the present subject matter;

FIG. 2A schematically depicts a cross-sectional side view of a resonator depicting a mechanical position of the moving mechanics of the resonator according to an example of the present subject matter;

FIG. 2B schematically depicts a cross-sectional side view of a resonator depicting a mechanical position of the moving mechanics of the resonator according to an example of the present subject matter;

FIG. 3A schematically depicts a cross-sectional side view of a resonator according to an example of the present subject matter;

FIG. 3B schematically depicts a cross-sectional side view of a resonator according to an example of the present subject matter;

FIG. 4 is a flowchart of a method used in a master node according to an example of the present subject matter;

FIG. 5 schematically depicts scattering parameters according to an example of the present subject matter;

FIG. 6 schematically depicts scattering parameters where two resonators are combined to form a 2 pole filter according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The present subject matter may allow to tune the center frequency (resonant frequency) of the resonator without moving mechanics for the tuner. The hollow dielectric tube that circumscribes the tuner may be adjusted or tuned (e.g., mechanically). In particular, the tuning of the center frequency may occur when the fixed metal tuner is at a predetermined position and the moveable dielectric tube circumscribes the fixed tuner providing different overlap lengths. This may avoid the metal-to-metal tunable mechanics and may provide low friction mechanical movement.

The present resonator may be a tunable cavity resonator. The resonant frequency of the cavity may, for example, be varied by changing any one of: cavity volume, cavity inductance, or cavity capacitance. For that, the resonator according to the present subject matter comprises the chamber. The chamber is defined or enclosed by the first wall, the second wall opposite the first wall, and side walls. The chamber may have a predefined size. The chamber may be referred to as cavity. The chamber may be a metal-walled chamber. For example, the walls of the chamber may be made of highly conductive material and enclose a good dielectric. The resonator comprises the first cylinder which is grounded on one of the first and second walls and extending into the chamber. The first cylinder may, for example, be a metallic cylinder emanating from the wall which forms the top of the cavity. The wall on which the first cylinder is grounded may be referred to as top wall.

The resonator comprises the second cylinder which is coaxial with the first cylinder. The second cylinder is grounded on the other wall of the first and second walls and extending into the chamber. The second cylinder may, for example, be a hollow metallic cylinder emanating on the opposite of the top side of the cavity. The wall on which the second cylinder is grounded may be referred to as bottom wall. The bottom wall may, for example, comprise a hole through which the dielectric tube may be inserted and accessed.

The tuner is coaxial with the second cylinder and grounded on the bottom of the first cylinder. The tuner may also be referred to as tuning element. The tuner may, for example, be a metallic tuner which may be connected to the bottom of the first hollow cylinder and to the cavity lid (e.g., top wall of the cavity). The bottom of the first cylinder is grounded on the top wall. For example, the tuner may be mechanically and electrically connected to the bottom of the first hollow cylinder and to the cavity lid. This may enable an electric current to flow along the tuner. This may provide a good stability and avoid current loss. The tuner may, for example, be a metallic screw.

The dielectric tube may be a moveable dielectric tube. The dielectric tube may be accessed through a hole of the bottom wall and configured to circumscribe the tuner along an overlap length. The hole may be used to access the dielectric tube and may allow a frequency agile operation. The hole may, for example, be a threaded hole. The hole may be formed in the bottom wall parallel to an axis e.g., of the second cylinder. The dielectric tube is coaxial with the hole. The dielectric tube may be moveable, slidable, removable, or insertable through the hole. The dielectric tube is coaxial with the second cylinder. The dielectric tube may be configured to surround or circumscribe the tuner along an overlap length. The overlap length may be the length of overlap between the dielectric tube and the tuner. The overlap length may be an adjustable overlap length as the dielectric tube may be tuned or adjusted to circumscribe different overlap lengths. The dielectric tube may, for example, be coaxial with the second cylinder. In one example, the dielectric tube is configured to circumscribe the tuner within the second cylinder. The dielectric tube may be a hollow tube. For example, the dielectric tube may be adjusted to circumscribe partially the metallic tuner e.g., part of the metallic tuner is circumscribed. The dielectric tube may be adjusted to circumscribe partially the metallic tuner within the second hollow metallic cylinder. This may be performed by moving the dielectric tube e.g., moving axially from down to top of the resonator. The movement of the dielectric tube may, for example, be calibrated in terms of frequency. For example, the adjustable overlap lengths within the second cylinder which are defined by the dielectric tube may be associated with respective resonant frequencies. Thus, the adjustment of the dielectric tube may be tuning the resonant frequency of the resonator. The dielectric tube may be a metallic dielectric tube.

According to the present subject matter, the overlap length refers the length of the tuner which is surrounded by the dielectric tube and the overlap part (or overlapping part) refers to the overlap between the first cylinder and the second cylinder.

The term “grounded” as used herein refer to fixing or rigidly fixing. The grounding may, for example, be performed mechanically by metal to metal contact based on smooth polished surfaces by means of pressure or another element e.g., a screw. The grounding may be performed for enabling electrical connection of the grounded element.

According to one example, the penetration level of the tuner and/or the overlap length may be adjusted in order to tune a resonant frequency of the resonator. The penetration of the tuner into the first and second cylinders may have the penetration level e.g., the penetration level may be a length of a part of the tuner which is extending into the hollow parts of the first and second cylinders. This may provide two parameters for controlling the resonant frequency of the resonator. For example, the resonant frequency may depend on the geometric parameters of the cavity which may be defined by the penetration level and the overlap level.

According to one example, the tuner is fixed at a penetration level which is associated with a predefined resonant frequency of the resonator. The tuner may be adjustable in length for frequency tuning. The tuner may, for example, be a metallic screw that may be fixed and refixed to desired penetration levels. The penetration level may provide a resonant frequency of the resonator. Using that resonant frequency as starting point, the overlap length may be adapted to increase or decrease that resonant frequency.

The dielectric tube is provided such that there might be a gap or no contact between the dielectric tube and the second cylinder. The dielectric tube is provided such that there is a gap or no contact between the dielectric tube and the tuner. The dielectric tube may be provided with a support for enabling the movement of the dielectric tube e.g., around the tuner.

According to one example, the second cylinder is an inner cylinder and the first cylinder is an outer cylinder lying coaxially to each other such that the first cylinder and the second cylinder overlap along part of their lengths. The overlapping cylinders may allow for better control of the tuning range of the resonator.

According to one example, the overlapping part between the first cylinder and the second cylinder is at the center of the chamber. For example, the hollow cylinders are overlapping at the center of the cavity.

According to one example, the first cylinder comprises a hollow part and a solid part, wherein the solid part is grounded on the top wall. This may provide a partially hollow cylinder. For example, the first cylinder may be a partially hollow metallic cylinder. The tuner may, for example, be grounded on the solid part of the first cylinder.

According to one example, the dielectric tube is configured to be adjusted mechanically to enable the overlap length. In this example, the movement of the dielectric tube may be optimally controlled.

According to one example, the dielectric tube is configured to be adjusted mechanically to enable the overlap length. This may enable a simplified and more compact design of the resonator while still providing reliable filtering functions.

According to one example, the resonator further comprises an electric motor that is attached to the dielectric tube. The electric motor may move along a drive shaft that is fixed at the tuner end and to the bottom wall. For example, the bottom wall may be provided with a protrusion to which the drive shaft is fixed. The electric motor may, for example, be configured to move axially along the drive shaft. The electric motor is coupled to the movement of the dielectric tube that circumscribes the tuner whereas the tuner is fixed. The electric motor may be configured to generate a translational movement for the dielectric tube.

According to one example, the motor is a piezo motor. The piezo motor may be a type of electric motor based on the change in shape of a piezoelectric material when an electric field is applied, as a consequence of the converse piezoelectric effect. The piezo motor may enable a high positioning precision, stability of position while unpowered, and may have the ability to be fabricated at very small sizes or in unusual shapes such as thin rings.

According to one example, the motor is a linear motor or stepper motor. The linear motor may produce a linear force along its length.

According to one example, a filter for radio frequency, RF, signals is provided. The filter comprises multiple resonators as described above. For example, the filter comprises two resonators as described above, wherein a wall between the resonant chambers comprises an opening for coupling between the resonators. In operation, a signal may be received via an input signal feed of the filter. The input signal may couple with the resonators. A filtered signal is then received at an output signal feed of the filter.

The present subject matter may be advantageous for the following reasons. No metal contact required for the tuner. The tuner is fixed to the cavity resonator. Once fixed, the tuner may not need to be mechanically adjusted. Since no moving mechanics may be used for the tuner, no mechanically adjustable metal contact may be required. The dielectric tube that circumscribes the metal tuner may be mechanically adjusted providing the necessary frequency tuning. The dielectric tube may not need to have a contact to the metal of the cavity resonator. The dielectric tube is not the tuner, and it works in combination with the fixed static metal tuner and the bottom hollow cylinder and thus it allows for a wide tuning range.

The present subject matter may bring a solution to the tunable resonator mechanics for coaxial resonators since it may circumvent the metal contact. This may enable upgraded repeatability and reliability, no adjustable metal contact and less friction. The present subject matter may enable a compact filter technology. The coupling may inherently remain stable in a very large range of tuning and may not require tuning mechanisms. This may simplify the mechanics and upgrades repeatability and the reliability. This may address mechanical resolution and mechanical stability problems.

The filter according to the present subject matter may be used in an element (e.g., base station) of a communication system. The communication system comprises nodes such as base stations, wherein each node may serve user equipments (UEs) located within the node's geographical area of service or a cell. The communication system may support one or more radio access technologies (RATs). A radio access technology of the radio access technologies may, for example, be evolved universal terrestrial radio access (E-UTRA) or 5G new radio (NR), but it is not limited to, as a person skilled in the art may apply the present subject matter to other communication systems provided with necessary properties.

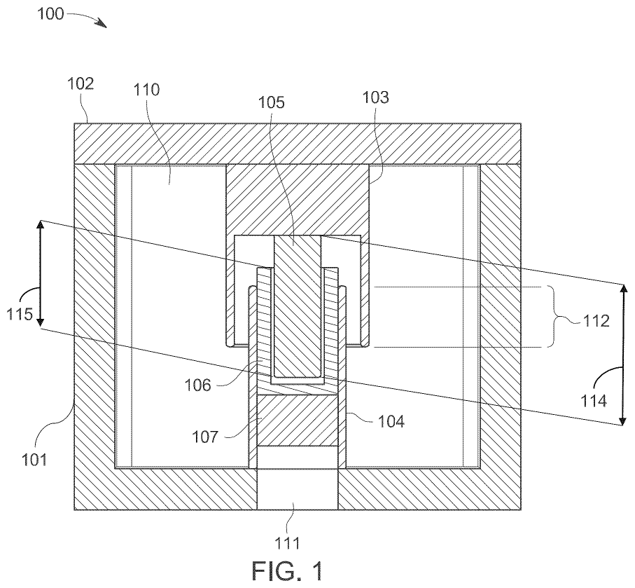

FIG. 1 schematically depicts a cross-sectional side view of a resonator according to an example of the present subject matter. The resonator 100 comprises walls formed by a cavity enclosure 101 and a cavity lid 102. The cavity enclosure 101 and cavity lid 102 may define a cavity 110 with a hole 111. The resonator 100 further comprises one partially hollow metallic cylinder 103 emanating from the top of the cavity. The resonator 100 further comprises a hollow metallic cylinder 104 emanating on the opposite side of the cavity and a metallic tuner/piston 105. The hollow cylinders may be overlapping in the overlap part 112 at the center of the cavity.

The metallic tuner 105 may be mechanically and electrically connected to the bottom of the hollow cylinder 103 and to the cavity lid 102. The tuner 105 is fixed. The tuner 105 is fixed such that it has a penetration level 114 within the chamber 110. A dielectric tube 106 is adjusted to circumscribe partially the metallic tuner 105 within the bottom hollow metallic cylinder 104. The dielectric tube 106 may circumscribe or surround the tuner 105 along the overlap length 115 between the dielectric tube 106 and the tuner 105. This adjustment is tuning the center frequency of the resonator. The dielectric tube 106 is provided with a support 107 for enabling the movement of the dielectric tube 106. The dielectric tube 106 is provided such that there is a gap or no contact between the dielectric tube 106 and the hollow metallic cylinder 104. The dielectric tube 106 is provided such that there is a gap or no contact between the dielectric tube 106 and the tuner 105.

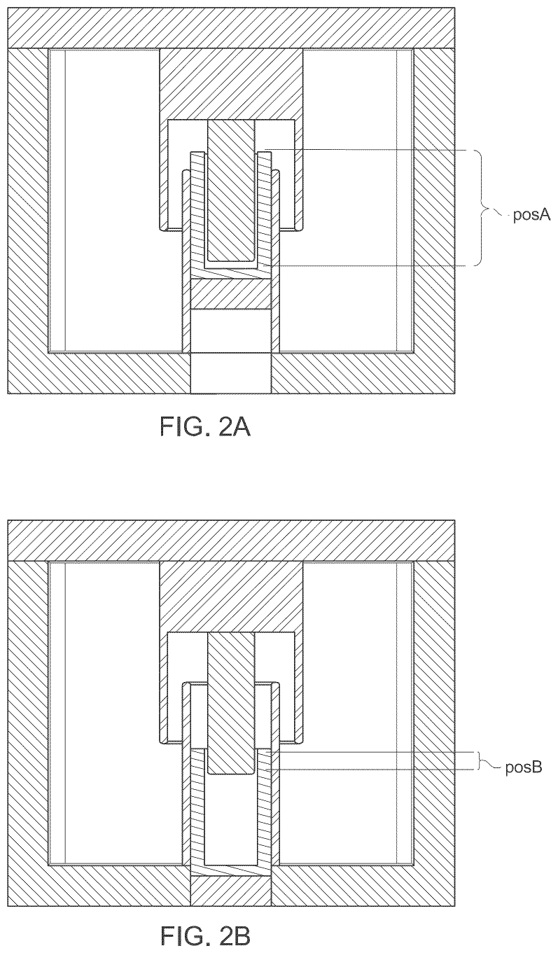

FIGS. 2A-2B schematically depict a cross-sectional side view of the resonator at two extreme positions respectively according to an example of the present subject matter. The two extreme positions may define two different overlap lengths. The first extreme position “pos A” in FIG. 2A is defined by a maximum overlap length of the tuner 105 which can be surrounded by the dielectric tube 106. The second extreme position “pos B” in FIG. 2B may be defined by a minimum overlap length of the tuner 105 which can be surrounded by the dielectric tube 106.

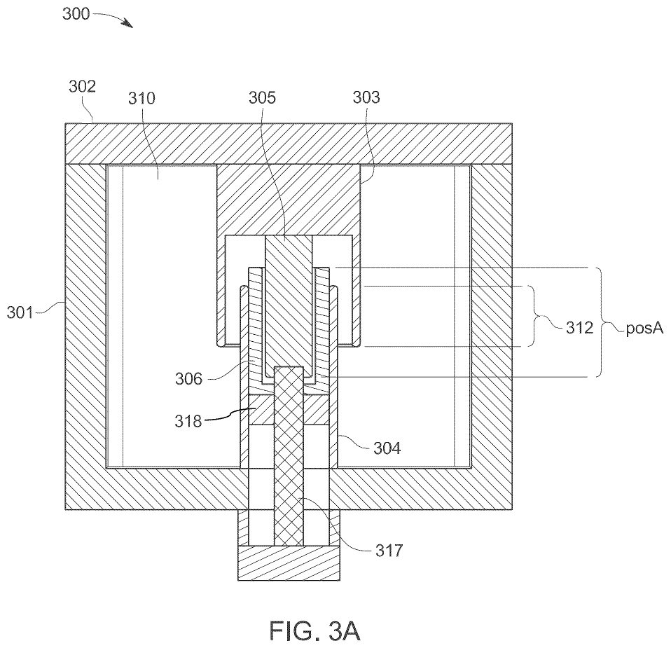

FIG. 3A schematically depicts a cross-sectional side view of a resonator according to an example of the present subject matter. The resonator 300 comprises walls formed by a cavity enclosure 301 and a cavity lid 302. The cavity enclosure 301 and cavity lid 302 may define a cavity 310 with a hole. The resonator 300 further comprises one partially hollow metallic cylinder 303 emanating from the top of the cavity 310. The resonator 300 further comprises a hollow metallic cylinder 304 emanating on the opposite side of the cavity and a metallic tuner/piston 305. The hollow cylinders may be overlapping in an overlap area 312 at the center of the cavity. The metallic tuner 305 may be mechanically and electrically connected to the bottom of the hollow cylinder 303 and to the cavity lid 302. The tuner 305 is fixed.

The resonator 300 further comprises a drive shaft 317 for enabling the movement of a motor 318. The drive shaft 317 is fixed on both sides, on one side to the metal tuner 305, on the other side to the cavity enclosure 301. The drive shaft 317 is fixed at the end of the tuner 305. A dielectric tube 306 is attached to the moving motor 318. The dielectric tube 306 as well as the motor 318 may not have contact with the hollow metallic cylinder 304.

The dielectric tube 306 is adjusted to circumscribe partially the metallic tuner 305 within the bottom hollow metallic cylinder 304. This adjustment is tuning the center frequency of the resonator. FIG. 3A shows one extreme mechanical position of tuning of the resonator 300 while FIG. 3B shows the other extreme mechanical position of tuning of the resonator 300.

Thus, as shown with reference to FIG. 1 and FIG. 3A, the mechanics of the resonator may be emanating on both sides of the cavity. The tuning element is totally within the resonator mechanics, the overlapping hollow cylinders. This may allow for better control of the tuning range of entire filter units. The drive shaft of the motor is attached on both sides so that the motor can move along the fixed drive shaft. The drive shaft is fixed on both sides and is static. The motor is coupled to the movement of the dielectric tube that circumscribes the tuning element whereas the tuning element is fixed. This may enable high levels of integration. The moving hollow dielectric tube may be penetrating the cavity of the inner volume of two overlapping cylinders, the bottom hollow cylinder and the metallic tuner. Only the volume between the cylinders can be accessed by the penetrating hollow dielectric tube. This may demonstrate a very compact solution which may be used with a linear motor or with a stepper motor for a tunable filter. A single motor serves a single resonator. The alternative implementation assumes a piezo motor with a central drive shaft, but is not limited to that.

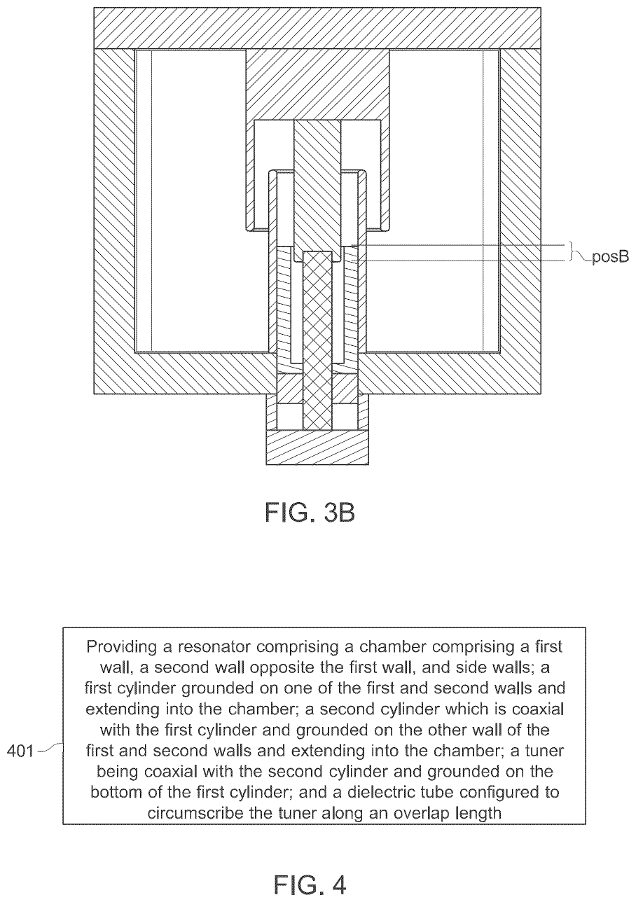

FIG. 4 is a flowchart of a method according to the present subject matter. The method comprises a step 401 of providing a resonator as described with reference to FIG. 1 or FIG. 3A-B. For example, a signal may be passed through at least one resonator for signal filtering purpose.

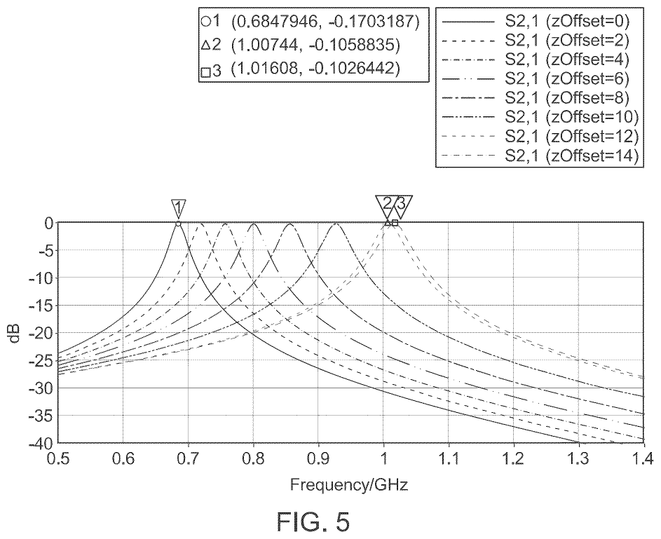

FIG. 5 schematically depicts scattering parameters (S-parameters) according to an example of the present subject matter along a vertical axis (magnitude in dB) over a frequency axis. FIG. 5 has been obtained by numerical simulation of a single resonator tunable filter for RF signals using a resonator e.g., of FIG. 1. Curves indicate S-parameter S2,1 (output port voltage reflection coefficient) for different zOffset values, wherein the zOffset value represents a respective overlap length between the dielectric tube and the tuner.

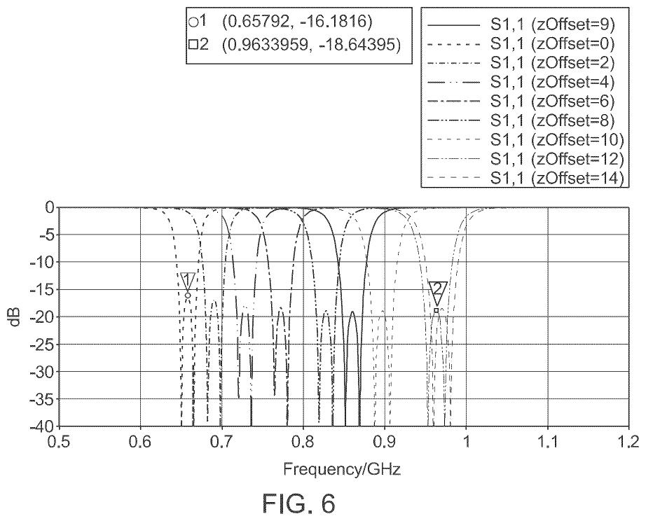

FIG. 6 schematically depicts scattering parameters (S-parameters) according to an example of the present subject matter along a vertical axis (magnitude in dB) over a frequency axis. FIG. 6 has been obtained by numerical simulation of a two-pole tunable filter for RF signals using a resonator e.g., of FIG. 1. Curves indicate S-parameter S1,1 (reverse voltage gain) for different zOffset values, wherein the zOffset value represents a respective overlap length between the dielectric tube and the tuner.

1. A resonator comprising
a chamber comprising a first wall, a second wall opposite the first wall, and side walls;
a first cylinder grounded on one of the first and second walls and extending into the chamber;
a second cylinder which is coaxial with the first cylinder and grounded on the other wall of the first and second walls and extending into the chamber;
a tuner being coaxial with the second cylinder and grounded on a bottom of the first cylinder; and
a dielectric tube being coaxial with the second cylinder and being configured to circumscribe the tuner along an overlap length.

2. The resonator of claim 1, being configured such that a frequency of the resonator is tuneable by adjusting at least one of: a penetration level of the tuner into the first and second cylinders or the overlap length.

3. The resonator of claim 1, wherein the tuner is fixed at a penetration level into the first and second cylinders which is associated with a predefined frequency of the resonator.

4. The resonator of claim 1, wherein the second cylinder is an inner cylinder and the first cylinder is an outer cylinder lying coaxially to each other such that the first cylinder and the second cylinder overlap along part of their lengths.

5. The resonator of claim 4, wherein the overlapping part between the first cylinder and second cylinder is at a center of the chamber.

6. The resonator of claim 1, wherein the dielectric tube is configured to be adjusted around the tuner mechanically to provide the overlap length.

7. The resonator of claim 1, wherein the dielectric tube is configured to be adjusted around the tuner electrically by an electric motor to provide the overlap length.

8. The resonator of claim 7, further comprising:
a drive shaft for enabling a movement of the electric motor along the drive shaft, the drive shaft being fixed to the tuner and to the other wall, wherein the dielectric tube is attached to the electric motor for enabling the adjustment of the dielectric tube.

9. The resonator of claim 8, the electric motor being a linear motor or a stepper motor, wherein the electric motor is a piezo motor.

10. The resonator of claim 1, the walls being metallic walls, the first and second cylinders being metallic cylinders, the tuner being a metallic tuner.

11. The resonator of claim 1, the dielectric tube being configured to circumscribe the tuner along the overlap length within the second cylinder.

12. A filter for radio frequency, RF, signals comprising multiple resonators in accordance to claim 1.

13. A method of radio frequency filtering comprising passing a signal for filtering through at least one resonator, the resonator comprising a chamber comprising a first wall, a second wall opposite the first wall, and side walls; a first cylinder grounded on one of the first and second walls and extending into the chamber; a second cylinder which is coaxial with the first cylinder and grounded on the other wall of the first and second walls and extending into the chamber; a tuner being coaxial with the second cylinder and grounded on the bottom of the first cylinder; and a dielectric tube being coaxial with the second cylinder and being aligned with a cavity hole on the other wall, the dielectric tube being configured to circumscribe the tuner along an overlap length.

14. The filter of claim 12, wherein a wall between the resonant chambers comprises an opening for coupling between the resonators.

15. The filter of claim 12, wherein the filter is configured to receive a signal via an input signal feed of the filter, couple the input signal with the resonators, and receive a filtered signal at an output signal feed of the filter.

16. A node comprising the filter according to claim 12.

17. The node of claim 16, wherein the node is a base station.
